(19) United States
(12) Patent Application Publication
(10) Pub. No.: US 2023/0381050 A1
(43) Pub. Date: Nov. 30, 2023

(54) RECONFIGURABLE EXOSKELETON DEVICE, MOUNTING PAD, MOTION CONTROL MODULE, MOUNTING PAD MOTION CONTROL MODULE SYSTEM, AND A METHOD OF REMOUNTING THE MOTION CONTROL MODULE

(71) Applicant: HoustonBionics, Inc., Santa Clara, CA (US)

(72) Inventors: Ali Utku Pehlivian, Santa Clara, CA (US); Mehmet Kutay Pehlivan, Santa Clara, CA (US)

(21) Appl. No.: 18/192,587

(22) Filed: Mar. 29, 2023

Related U.S. Application Data
(60) Provisional application No. 63/325,143, filed on Mar. 29, 2022.

(51) Int. Cl. A61H 1/02

(52) U.S. Cl. CPC A61H 1/0281; A61H 2201/165; A61H 2201/1685; A61H 2201/1614; A61H 2201/1635

(57) ABSTRACT

A device may include an exoskeletal device with shaft connections and mounting pads corresponding to axes of rotation of the joints of the patient. A device may include a motion control module with a housing surrounding a shaft-based internal system that provides at least one of resistance or assistance to the exoskeletal device's motion through a drive shaft and is connectable to the shaft connections and the mounting pads of the exoskeletal device, wherein the motion control module has a locked position on each of the mounting pads when the drive shaft is in communication with the corresponding shaft connections and the housing is fixed relative to each of the mounting pads.

### CROSS-REFERENCE TO RELATED APPLICATIONS

This application is a non-provisional claiming priority to and benefit of U.S. Provisional Patent Application No. 63/325,143, filed on Mar. 29, 2022. That application is incorporated by reference in its entirety.

### BACKGROUND

Patients undergo physical therapy for a variety of reasons. The physical therapist uses a variety of exercises to test or develop the range of motion for their patients. In some cases, there are a variety of machines that can be used to facilitate the physical therapy.

### SUMMARY

In some aspects, the techniques described herein relate to an interchangeable mounting system on an exoskeletal device for controlling motion of joints of a patient, the system including: an exoskeletal device with shaft connections and mounting pads corresponding to axes of rotation of the joints of the patient; a motion control module with a housing surrounding a shaft-based internal system that provides at least one of resistance or assistance to the exoskeletal device's motion through a drive shaft and is connectable to the shaft connections and the mounting pads of the exoskeletal device, wherein the motion control module has a locked position on each of the mounting pads when the drive shaft is in communication with the corresponding shaft connections and the housing is fixed relative to each of the mounting pads.

In some aspects, the techniques described herein relate to an interchangeable mounting system, wherein each of the mounting pads has a locking latch that engages with a locking slot on the housing of the motion control module.

In some aspects, the techniques described herein relate to an interchangeable mounting system, wherein each of the mounting pads has a docking ledge that engages with a docking slot on the housing when the motion control module is in the locked position.

In some aspects, the techniques described herein relate to an interchangeable mounting system, wherein the locking latch is spring loaded and has a finger joystick extending away from the mounting pad.

In some aspects, the techniques described herein relate to an interchangeable mounting system, wherein the locking latch is biased by the spring into a locked position and must be actuated by the finger joystick to disengage the locking latch.

In some aspects, the techniques described herein relate to an interchangeable mounting system, wherein the resistance is provided through mechanical dampers inside the motion control module's housing.

In some aspects, the techniques described herein relate to an interchangeable mounting system, wherein the resistance is provided in proportion to the speed of the patient's motion.

In some aspects, the techniques described herein relate to an interchangeable mounting system, wherein the assistance is provided through an electrical actuator inside the housing.

In some aspects, the techniques described herein relate to an interchangeable mounting system, wherein the assistance is provided for a portion of the desired patient's motion.

In some aspects, the techniques described herein relate to an interchangeable mounting system, wherein the assistance is provided for the entirety of the desired patient's motion.

In some aspects, the techniques described herein relate to an interchangeable mounting system, wherein the exoskeletal device includes an arm and shoulder attachment having two of the mounting pads.

In some aspects, the techniques described herein relate to an interchangeable mounting system, the motion control module is configured to be moved from a first of the mounting pads corresponding to a first axis of rotation to at least one mounting pad corresponding to a second joint,

In some aspects, the techniques described herein relate to a method of remounting a motion control module on an exoskeletal device, the method including the steps of: releasing, by depressing an actuator of a spring-loaded locking latch, a motion control module from its locked position on a first mounting pad; rotating the motion control module from the locked position to a docking position on the first mounting pad; removing the motion control module from the first mounting pad; placing the motion control module on a second mounting pad in a docking position so that a shaft of the motion control module extends through a hole of the second mounting pad; and rotating the motion control module from the docking position on the second mounting pad to a locked position on the second mounting pad.

In some aspects, the techniques described herein relate to an interchangeable motion control module, the motion control module including: a shaft engageable with socket of an exoskeletal device; a housing with a locking slot and a docking slot for engaging respectively with a locking latch and a docking ledge of a mounting pad on the exoskeletal device.

In some aspects, the techniques described herein relate to a mounting pad for engaging with a motion control module, the mounting pad including: a docking ledge, a mounting pad hole, and a spring-loaded locking latch, wherein the mounting pad hole is configured for receiving a shaft of a motion control module, the docking ledge is configured for engaging with a docking slot of the motion control module when inserting the motion control module onto the mounting pad, and the spring-loaded locking latch is configured to lock into a fixed position the motion control module when it has been rotated from the docking ledge to the spring-loaded locking latch.

In some aspects, the techniques described herein relate to a mounting pad motion control module system, the system including: a mounting pad including a docking ledge, the mounting pad hole, and a spring-loaded locking latch; a motion control module including a locking slot, a docking slot, and a shaft, wherein the motion control module provides at least one of resistance or assistance to the motion of the shaft, the motion control module can removably attached to the mounting pad with its shaft penetrable through the mounting pad hole, the docking slot engages with the docking ledge when the motion control module is placed onto the mounting pad, the locking slot engages with a spring-loaded locking latch to hold the motion control module in a fixed position relative to the mounting pad.

In some aspects, the techniques described herein relate to a mounting pad motion control module system, wherein the spring-loaded locking latch is releasable through the depression of an actuator that enables a user to rotate the motion control module relative to the mounting pad.

In some aspects, the techniques described herein relate to a method for remounting a motion control module on an exoskeletal system, the method including: unlocking a motion control module from the locked position to an unlocked position on a first mounting pad; removing the motion control module from the first mounting pad causing a drive shaft of the motion control module to be extracted from the XO skeletal the system through a first mounting pad hole on the first mounting pad; moving the motion control module to a second mounting pad and causing the driveshaft of the motion control module to be inserted into the exoskeletal device through a second mounting pad hole on the second mounting pad; and locking the motion control module from an unlocked position to a locked position on the second mounting pad.

In some aspects, the techniques described herein relate to a method, further including a step of disconnecting electrical connections between the first mounting pad and the motion control module and a step of connecting electrical connections between the motion control module and second mounting pad.

In some aspects, the techniques described herein relate to a method, wherein the step of unlocking involves releasing a locking latch from a locking slot and rotating the motion control module.

In some aspects, the techniques described herein relate to a method, wherein the step of locking involves rotating the motion control module until a locking slot engages with a locking latch.

### BRIEF DESCRIPTION OF THE DRAWINGS

The accompanying drawings, which are incorporated in and constitute a part of this specification, illustrate examples, and together with the description, serve to explain the principles. The drawings are not to scale unless otherwise specified.

FIG. 1A is a perspective view of an example exoskeletal device. FIG. 1B is a second perspective view of the example exoskeletal device from a different angle. FIGS. 1C and 1D respectively are annotated versions of FIGS. 1A and 1B highlighting various joint rotation axes.

FIG. 2 is a wire frame drawing of an example arm and shoulder attachment of an exoskeletal device.

FIG. 3 a depicts a table showing example anatomical ranges of upper extremity movements and corresponding exoskeletal device ranges.

FIGS. 4A-4F depict an example motion control module. FIG. 4A is a side view showing the docking slot and the shaft. FIG. 4B is a bottom side perspective view showing the docking slot and the shaft. FIG. 4C is a bottom side perspective view showing the locking slot and the shaft. FIG. 4D is a top side perspective view showing the locking slot. FIG. 4E is a bottom view showing the shaft. FIG. 4F is a top view showing finger grips.

FIGS. 5A-5F our views of an example mounting pad. FIG. 5A is a top view of the mounting pad. FIG. 5B is a top side perspective view of the example mounting pad. FIG. 5C is a side view of the example mounting pad showing the locking latch mechanism. FIG. 5D is a side view of the example mounting pad from the opposite view of FIG. 5C. FIG. 5E is a front view. FIG. 5F is a top side perspective view of the mounting pad.

FIGS. 6A and 6B show two different perspective views of the mounting pad with the motion control module in locked position.

FIGS. 7A and 7B show two different perspective views of the mounting pad with a motion control module and an unlocked position.

Reference numerals may be inconsistently applied. Similar components across similar figures may not be referenced more than once, except for convenience or illustrated something in context. Some of the figures have a red dot that is a remnant of the cursor position in the CAD software. The red dot is meaningless and should be ignored.

### DETAILED DESCRIPTION

Described herein is a removable mounting system for engaging with joint control of an exoskeletal device. Also described herein are methods for disengaging and engaging a motion control module with various mounting pads. The systems, methods, and devices described herein have several benefits that will be discussed below.

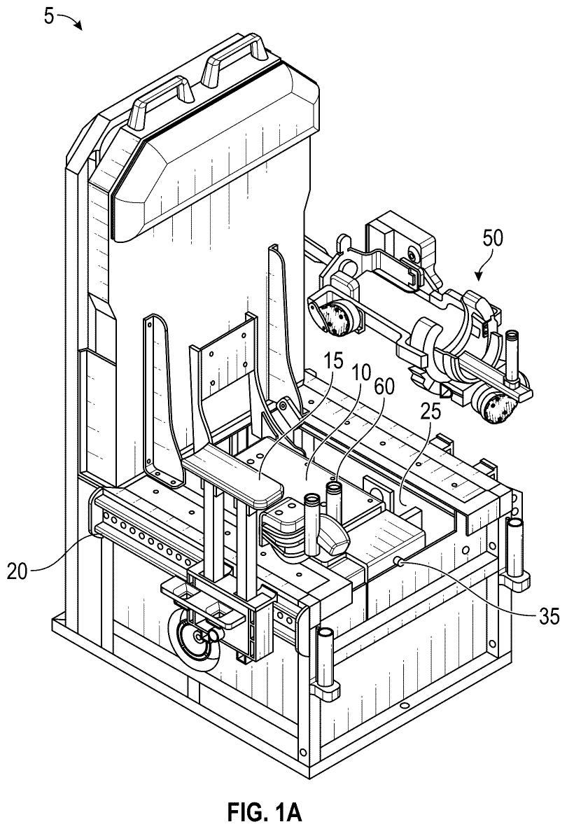

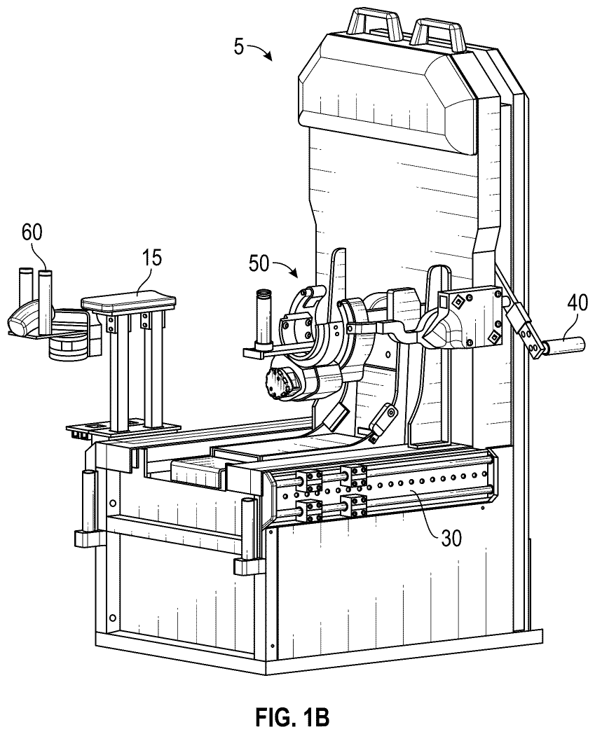

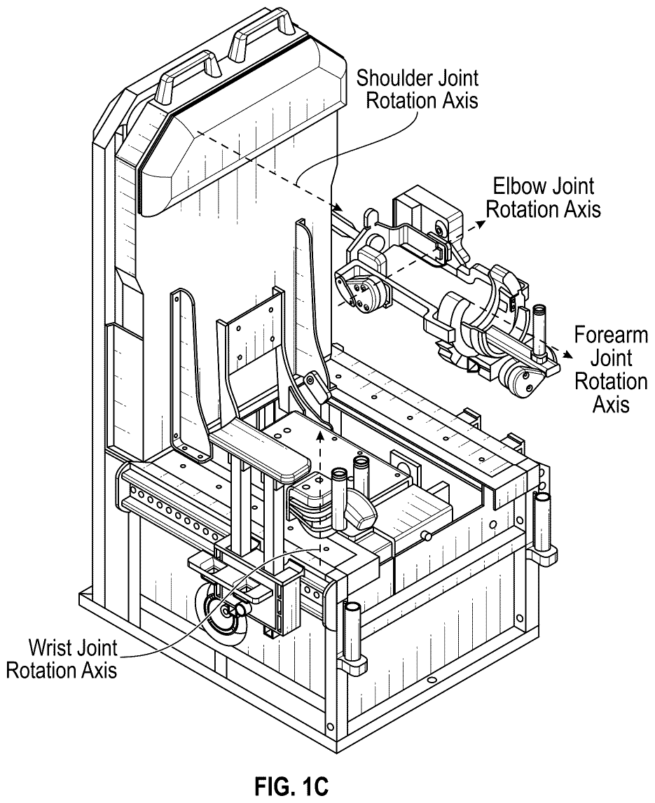

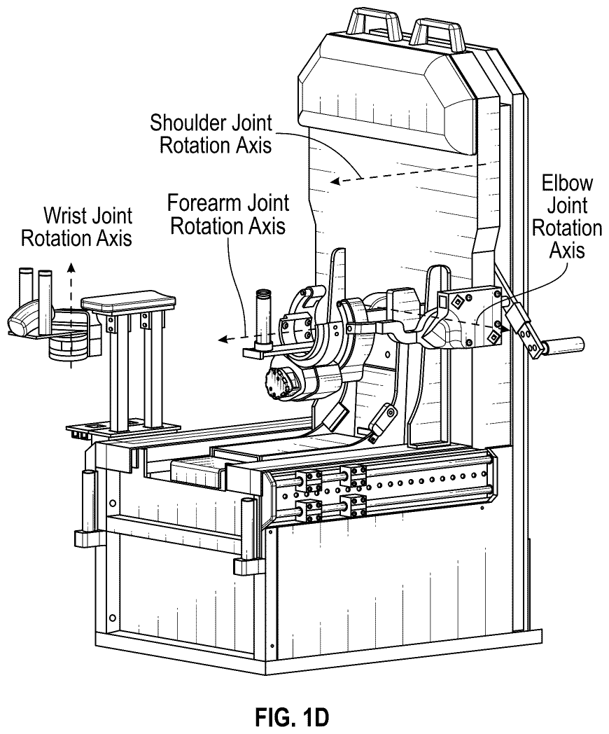

FIG. 1A is a perspective view of an example exoskeletal device. FIG. 1B is a second perspective view of the example exoskeletal device from a different angle. FIGS. 1C and 1D respectively are annotated versions of FIGS. 1A and 1B highlighting various joint rotation axes.

The example exoskeletal device with arm and shoulder attachment 50 or wrist attachment 60 is designed to be worn or manipulated by the user while sitting in the patient seating area 10. The device is optionally outfitted with various adjustment mechanisms 20, 25, 30, 35, 40 to adjust the seat in one or more axes (horizontal 35, depth 25) or device components relative to each other and armrest(s) 15. The example embodiments shown are used for the upper extremity movements corresponds to the users' shoulder (for abduction/adduction motion), elbow (for flexion/extension motion), forearm (for pronation/supination motion), and wrist (for flexion/extension and radial/ulnar deviation motions) joints. FIGS. 1C and 1D are annotated versions of FIGS. 1A and 1B showing axes of rotation.

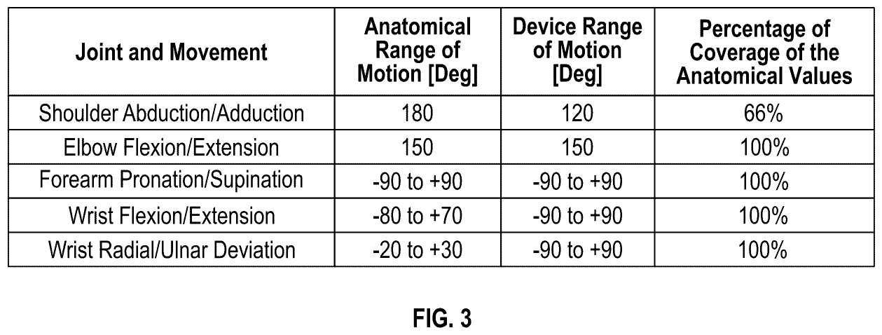

FIG. 3 depicts a table showing example anatomical ranges of the upper extremity movements and corresponding device ranges. Lower extremity movements or other motions can be controlled similarly.

The exoskeleton 5 can be passive, allowing for the user to start and carry out the movement. Gravity compensation is optionally implemented with counterweights or otherwise on the elbow, shoulder and/or other joints to cancel out the exoskeletal device's weight to isolate the joint(s) of interest. The motion can be isolated (involves a single joint while other joints are locked) or functional (involves multiple joints). The motion control modules 95 are used to assist or resist the movement for various training modalities.

The motion control module 95, inside the housing 100, has at least one internal system 105 connected to the shaft 150. For example, to create resistance against the users' motion, the example embodiments of the motion control module may employ mechanical dampers inside the motion control module's housing 100 to generate a resistance proportional to the speed of the user's movement. Additionally or alternatively, a different kind of resistance could be created using a rotary dashpot. Additionally or alternatively, to create assistance, an electrical actuator including but not limited to a solenoid can be used inside the housing 100. The actuator in the motion control module 95 provides active assistance for the whole or the desired portion of the movement. Although one embodiment of a housing 100 is depicted in the figures, the shape of housing 100 may be altered to accommodate different internal systems 105. Not shown may be optional features shaped or adapted to help secure the internal system 105 into a fixed position inside housing 100. This may be a tight fit, fasteners, or various other things known in the art to prevent rotation of the internal system 105 relative to the housing 100 so that the shaft 150 moves.

The example motion control modules 95 have a benefit when a user population is neurologically affected on one side of the body. For example, the motion control module 95 (either for assistance or resistance training) is easily mountable to the desired joint using the un-affected hand and then remountable to other joint.

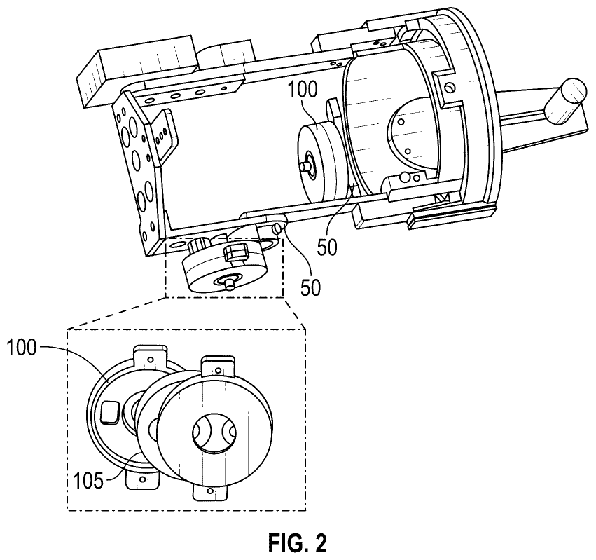

FIG. 2 is a wire frame drawing of an example arm and shoulder attachment 50 of an exoskeletal device. This example wire frame of the arm and shoulder attachment contains two mounting pad locations where motion control modules can be inserted for controlling or responding to joint movement. There is at least one mounting pad corresponding to every joint that the exoskeleton is intended to work.

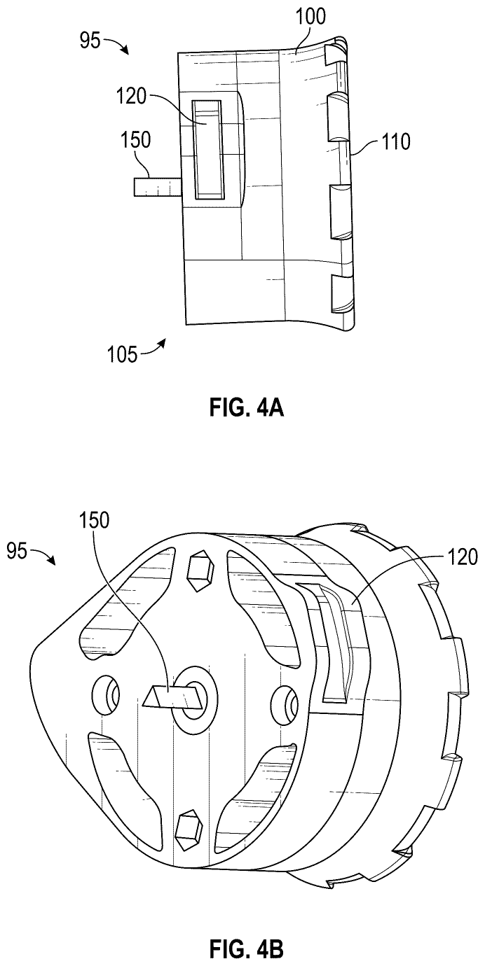

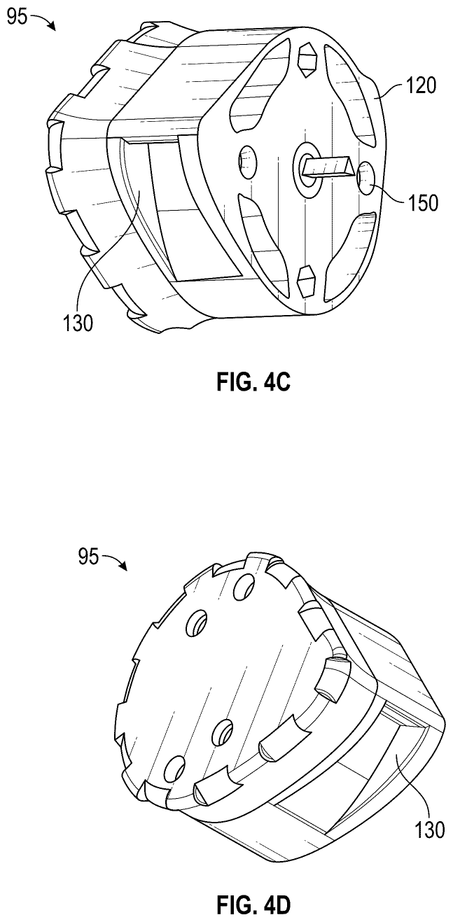

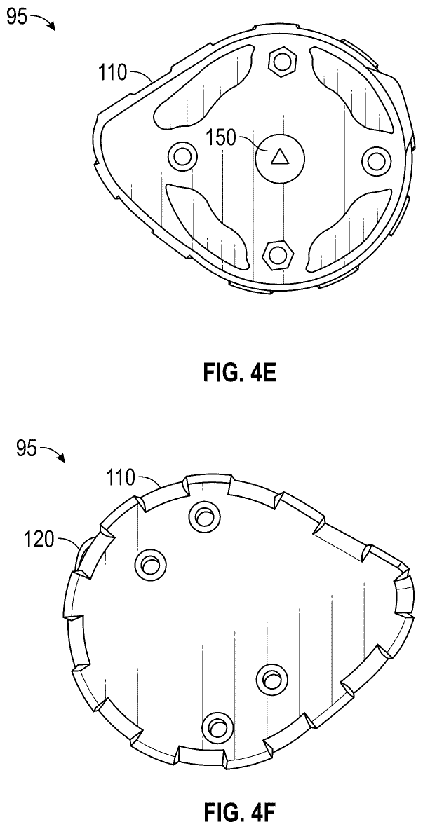

FIGS. 4A-4F depict an example motion control module. FIG. 4A is a side view showing the docking slot 120 and the shaft 150. FIG. 4B is a bottom side perspective view showing the docking slot 120 and the shaft 150. FIG. 4C is a bottom side perspective view showing the locking slot 130 and the shaft 150. FIG. 4D is a top side perspective view showing the locking slot 130. FIG. 4E is a bottom view showing the shaft 150. FIG. 4F is a top view showing finger grips 110 on the motion control module 95.

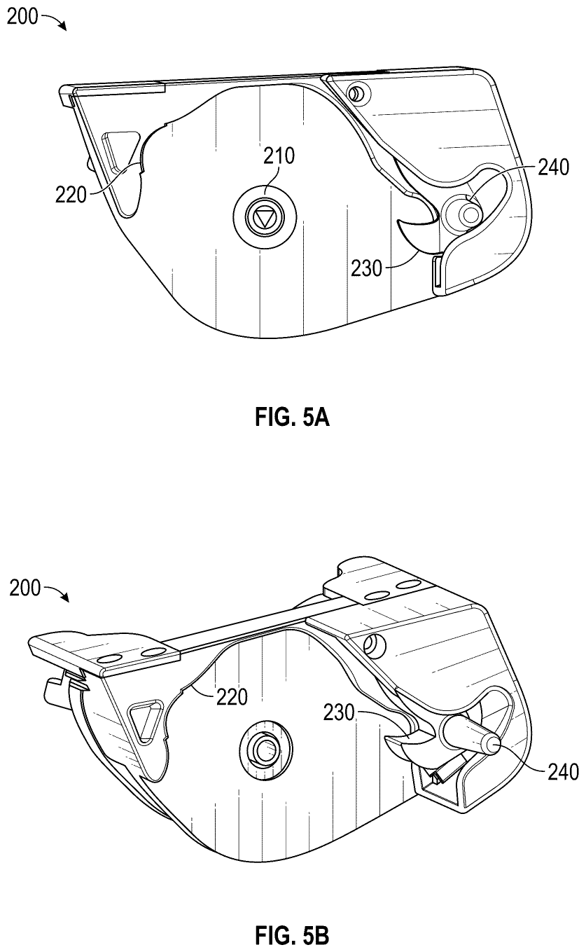

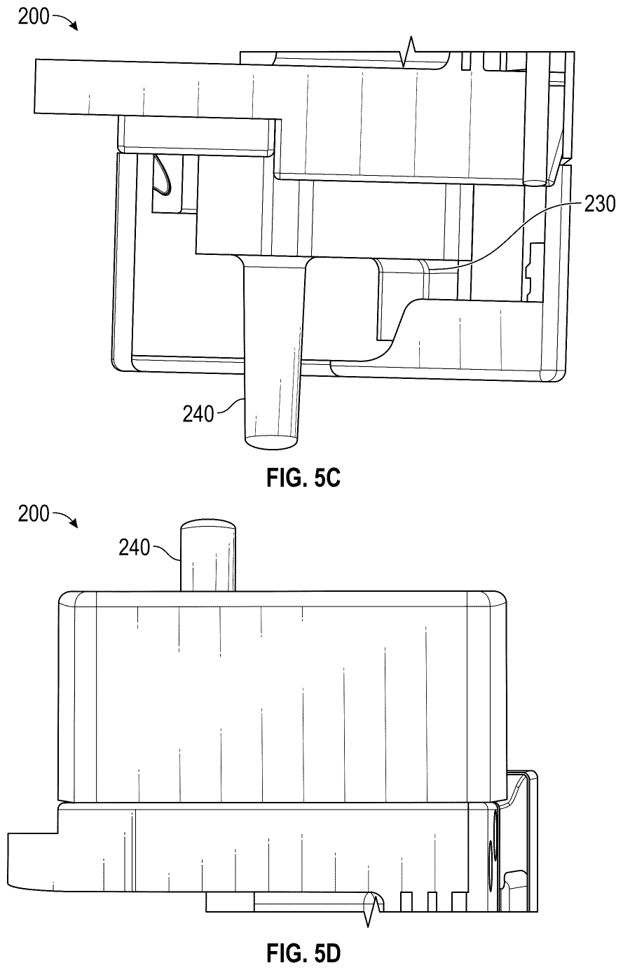

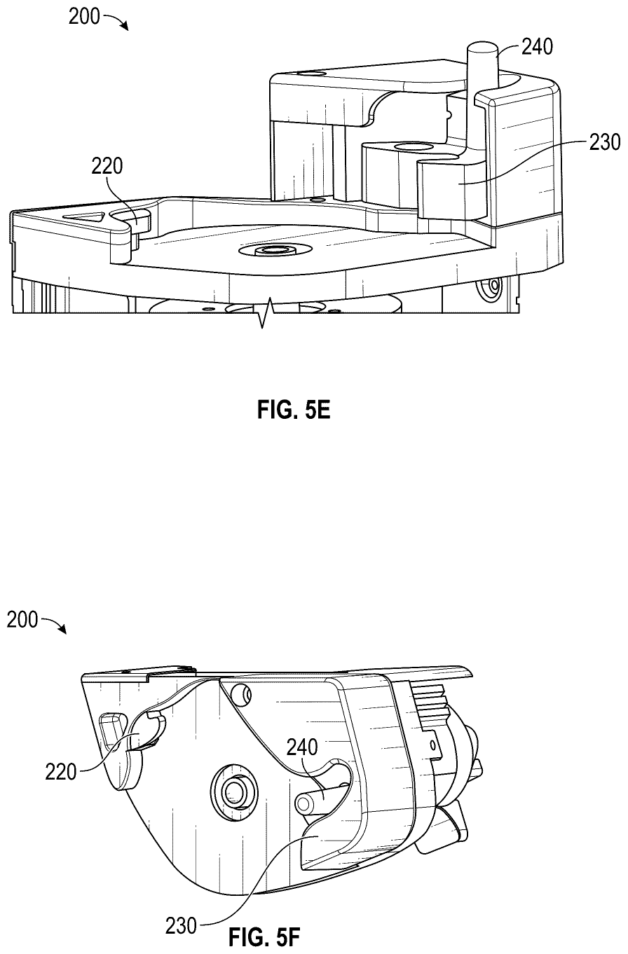

FIGS. 5A-5F our views of an example mounting pad. FIG. 5A is a top view of the mounting pad. FIG. 5B is a top side perspective view of the example mounting pad. FIG. 5C is a side view of the example mounting pad showing the locking latch mechanism. FIG. 5D is a side view of the example mounting pad from the opposite view of FIG. 5C. FIG. 5E is a front view. FIG. 5F is a top side perspective view of the mounting pad.

The example design utilizes a triangular shaft 150 profile, a locking slot 130 on the motion control module 95, and a docking slot 120. The example motion control module is mounted by inserting the triangle shaft through the mounting pad hole and matching it to the triangle socket (not shown) on the exoskeleton corresponding to the patient's joint. The motion control module 95 is then rotated counterclockwise until the docking slot 120 matches the docking ledge 220 and the spring-loaded locking latch 230 matches the locking slot 130. In this position, the example motion control module 95 is locked.

The bottom (e.g., exoskeleton side) of the motion control module 95 is flat to mate with the surface of the mounting pad 200. The bottom can be other shapes if its surface pairs with and/or is complementary to the mounting pad's contours.

The example design of the housing 100 includes a top and a bottom that are fastened together with internal systems 105 between the top and the bottom and the shaft 150 extending outward from the bottom.

The example shaft 150 is a strong material that can transmit or resist the rotational torque differences at the joints of the exoskeletal device and the mounting pad module remotely located. Such materials include metal or alloys. It may be possible to replace the mechanical shaft drive system with a magnetic (e.g., induction) drive system.

The housing can be molded of plastic or construed of other material that can be easily shaped to perform the functions described herein. Along the top of the housing 100 or finger grips 110 to assist with create additional traction and a grip for the patient's fingers during rotation. Here, the finger grips 110 are shown as ridges or indentations. Finger grips 110 could additionally or alternatively be tacky or non-slip material.

The example motion control module 95 has features on the side of the housing 100. A first feature is a locking slot 130. This locking slot is designed to interact with a locking latch 230 on the mounting pad. A second feature is a docking slot 120. The docking slot 120 is designed to interact with a docking ledge 220.

The motion control module 95 can then rotated by the user's hand or electronically through an electro-mechanical system until the locking slot 130 approaches and eventually engages with the spring-loaded locking latch 230. The spring-loaded locking latch 230 is able to enter the locking slot 130 and hold the module in place. The user does not need to be mechanically sophisticated. Although a spring-loaded latch is used in the example embodiment, other mechanical, magnetic, or electromechanical forms of locking, latching, securing and fastening can be used to create the locked position. For example, another locking system could be a spring based or servo motor driven detent system that triggers and untriggers. In the event of a detent, the locking slot would more likely be a locking hole.

The locking slot 130 is shown as a crevice that gets increasingly deep crevice until it reaches its endpoint and then has an abrupt height difference. This shape is beneficial to create an easy surface for the spring loaded locking latch 230 to grab onto. Other shapes may work as well such as a simple slot. Other types of fasteners may work such as a Velcro strap system around at least some of the perimeter of the motion control module 95 to hold the mounting module in place and arrest its rotation. Or a mechanically or electrically controllable (e.g., a solenoid) ball or spring based detent or latching systems engaging along the mating surface or side surface between the mounting pad 200 and the motion control module 95 can prevent movement.

In the example embodiment, across from the locking slot 130 on the motion control module 95 on the opposed side of the housing sits a second place to secure the motion control module. Given the forces and the rotational torque generated and transmitted along the drive shaft by the exoskeleton during usage, effectively securing the motion control module 95 is important. Because the engaged spring-loaded locking latch is able to arrest the rotation of the module, the docking slot can, but does not have to, control the rotation. In this way, only a docking ledge 220 preventing up or down movement, which engages with a groove-shaped docking slot is able to adequately secure the module 95, across from the spring-loaded locking latch 230 that is actuated with a finger joystick 240. This design makes it easy for the user to engage or disengage the motion control module 95 from the mounting pad 200. A person of skill in the art can envision more than one locking latch or other mechanism and place of the docking ledge. The motion control module and the mounting pad may have a rail and groove system to facilitate correct motion along the motion control module/mounting pad connection.

For manufacturing cost and simplicity, common mechanical elements as shown in the example embodiment of FIGS. 1-7B can be used over more complex systems. It is noted that in some embodiments, more complex systems that are known in the art or their equivalents can replace or supplement the systems used for controlling the mounting locking and rotation of the motion control module/mounting pad interface. The shaft is the drive mechanism for the resistance mechanism for the patient's motion. The shaft is preferably shaped to enter into a shaft socket in the main exoskeletal device. However, this could be reversed, where the main device has the shaft socket shaped to match the shaft. That is, the shaft can be on the main mechanism, or it could be on the mounting module. Alternatively, the control of the drive can be achieved through electromagnetic means.

The system has a benefit of significant cost savings, and increasing the accessibility through such cost savings, by having the reconfigurable mounting system. Instead of having one drive mechanism at the location of each and every joint, significant cost savings can be achieved by having a single or fewer modules 95 including internal systems 105 that can be moved to the joint of interest. This allows the system to be more affordable for home use.

Alternatively, this affordability can be made available to the equipment in physical therapy centers to lower their costs. Fewer drive mechanisms can result in cost savings and weight savings of the exoskeleton device. This makes an exoskeleton device cheaper and more portable for a traveling physical therapist.

Additionally, having fewer mounting systems may make the system easier and that it can reduce electrical pathways through the device end result in a cheaper main device. This is not to say that the main device cannot have many electrical Pathways, but it does open up the possibilities of different options. Another benefit is the simplicity for the user to be able to move around the mounting mechanism without having the level of expertise of an engineer.

While the specification mainly discussed is the main device as tool for physical therapy, this system may be used outside of the physical therapy context for other systems that require similar motions and resistance/assistance control such as exercise or weight training equipment.

In some embodiments where power is used in the mounting pad module 95, the electrical contacts and electrical wiring can be unique to the mounting module, or they can be on the mounting pad or on other parts of the exoskeletal device. For example, the mounting module could have an electrical cord that could be pluggable into a wall outlet or a different power source. Additionally or alternatively, the motion control module 95 receive its electricity from a battery therein. Additionally or alternatively, the motion control module 95 could receive electricity through electrical contacts (not shown) through the shaft 150 or the mounting pad 200. On the mounting pad, these contacts could be positioned on any of the mating surfaces such as the docking ledge 220 or the top mating surface or the mating rim of the mounting pad 200. Wires or other electrical communication mediums can carry power around the motion control module 95, the mounting pad 200, or the exoskeletal device 5. Electrical is relevant for electrical lock control and position and motion awareness sensors, which assist in the usage of the device and feedback to the user.

In some embodiments, docking slot 120 is formed by the lower surface of an upper ridge and an upper surface of a lower ridge. Additionally or alternatively, the upper and lower ridges protrude out from the housing. In some embodiments, the upper ridge can extend all or almost the entire circumference of the housing 100. In other embodiments, the upper ridge can be minimal. In this design, the housing 100 comes into contact with the mating surface of the mounting pad 200 and the docking ledge 220 engages with the docking slot as the housing is rotated. This provides support to the housing 100 at a different position from the locking slot 130 spring loaded locking latch 230 contact point. Each of the shaft 150, junction between the locking slot 130, spring loaded locking latch 230, and junction between the docking slot 120 and docking ledge 220 provide support to the housing when in the locked position. It is possible to have a reversed arrangement from the example embodiment with a docking ledge on the motion control module 95 and a docking slot on the mounting pad 200. In other embodiments, more or less support points or locking mechanisms are possible. The combination of the locking pad and the support(s) around the housing 100 should be strong enough to maintain a stable connection between the motion control module 95 and the mounting pad 200 during resistance or assistance.

The spring loaded locking latch 230 in the example embodiment has a default bias to the locked position. The locking latch 230 is shaped to be pushed out of the way into a curved gap as the latch 230 engages the housing's 100 front edge or material ahead of the locking slot 130 as the motion control module 95 is mounted and rotated into place. The auto retraction of latch 230 only operates in that direction, so the motion control module 95 does not unintentionally unlock. A second hand is not required to mount the motion control module 95 but can assist to unlock the spring loaded locking latch 230 for user's that are unable to make the unlocking motion with their primary hand used for rotating the motion control module 95.

As an addition or alternative to figure joystick 240, an actuator, switch or pushbutton (collectively “pushbutton”, not shown) on housing 100 or on mounting pad 200 can engage and disengage the spring loaded locking latch 230 or a locking mechanism directly on or proximate to the shaft 150, on housing 100 or on mounting pad 200. By pushing the pushbutton, the user can disengage the lock with a connection near the mounting pad hole 210 and remove the housing 100 from the mounting pad 200. This alternative design optionally can have one or more docking slots on the housing 100 for extra support, and optionally can be combined with a rotatable engagement with docking slots with a docking ledge on the mounting pad.

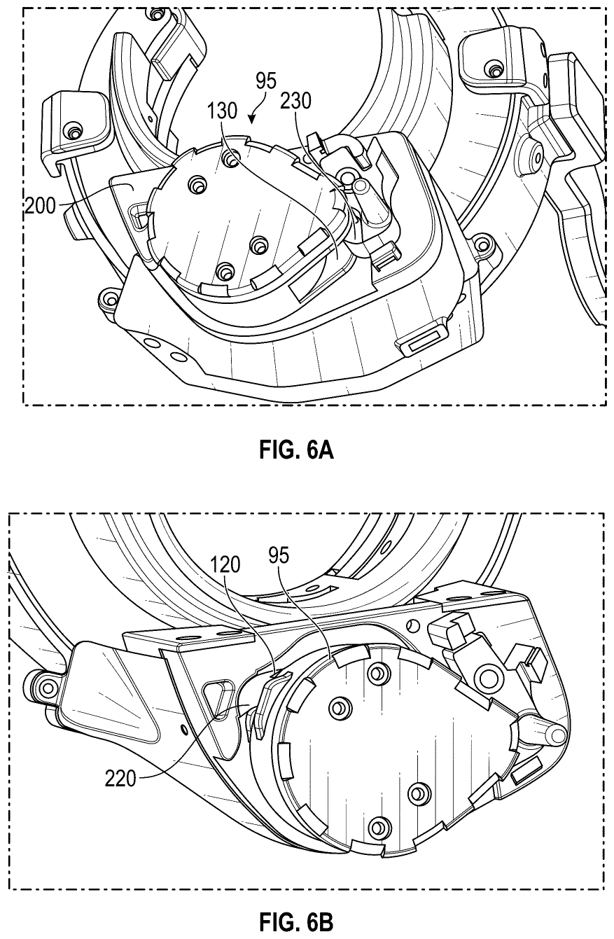

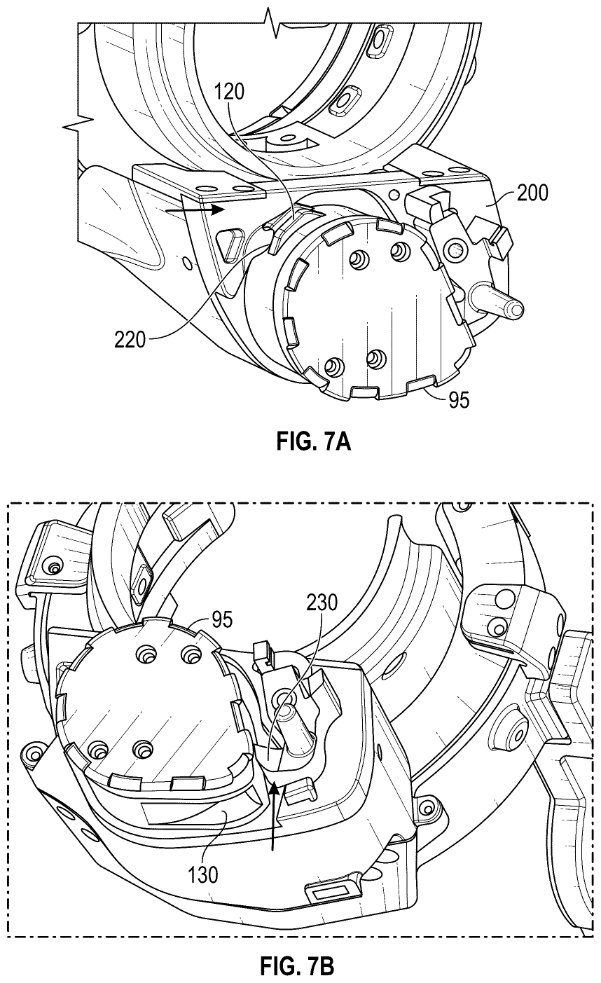

FIG. 6A depicts the locking slot 130 of the motion control module 95 engaged with the spring loaded locking latch 230 of the mounting pad 200. That is, FIG. 6A shows the locked position. FIG. 6B depicts the motion control module in the same position as in FIG. 6A with a view highlighting the docking ledge 120 interface. Here, docking slot 120 is engaged with docking ledge 220. In contrast, FIGS. 7A and 7B depict the motion control module 95 in an unlocked position. At the red arrow, FIG. 7A depicts the docking ledge 220 not fully engaged with the docking slot 120. At the red arrow, FIG. 7B depicts the spring loaded locking latch 230 in an unlocked position next to the motion control module 95 and not engaged with docking slot 130.

There has thus been outlined, rather broadly, some of the features of the device and methods in order that the detailed description thereof may be better understood, and in order that the present contribution to the art may be better appreciated.

Although methods and devices similar to or equivalent to those described herein can be used in the practice or testing of the device and methods, suitable methods and materials are described above. The device and methods may be embodied in other specific forms without departing from the spirit or essential attributes thereof, and it is therefore desired that the present embodiment be considered in all respects as illustrative and not restrictive. Other objects and advantages of the various embodiments of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

It will be apparent to those skilled in the art that various modifications and variation can be made to the disclosed methods, software, hardware, materials, components, and methods herein. Other embodiments will be apparent to those skilled in the art from consideration of the specification and practice of the disclosed inventions. Numerous modifications, changes, variations, substitutions, and equivalents will occur to those skilled in the art without departing from the spirit and scope of claimed invention. It is intended that the specification and examples be considered as exemplary only, with a true scope being indicated by the claims and their equivalents. The benefits, advantages, solutions to problems, and any element(s) that may cause any benefit, advantage, or solution to occur or become more pronounced are not to be construed as a critical, required, or essential features or elements of any or all the claims. Accordingly, the specification and figures are to be regarded in an illustrative rather than a restrictive sense, and all such modifications are intended to be included within the scope of the claimed invention.

Unless otherwise defined, all technical and scientific terms used herein have the same meaning as commonly understood by one of ordinary skill in the art to which the claims features belong. Moreover, Applicant's inconsistent use of a term should not be construed as different terms unless defined by Applicant or the context. Likewise, it is to be understood that the phraseology and terminology employed herein are for the purpose of the description and should not be regarded as limiting. Regarding additional interpretation and construction of terms and steps herein, method steps are not in any specified order unless dictated by the context or specific wording. In addition, the use of a word in the singular form should be interpreted where the context allows or does not restrict so as to enable plurality or an “at least one” construction. Positional and directional terms described in this specification may be understood to be different than shown or described and should not limit the variations of embodiments possible from the claimed features that a person of ordinary skill in the art would understand from the specification, figures, and claims. The term “and/or” in a list means all list items present, some list items present, or one of the list items present, unless such construction is limited by the context. “Including” shall be construed as “including but not limited to.” In the claims, unless the context provides otherwise, the use of cardinal or ordinal numbers to describe components should not be limited to a construction only including those components having such numbers or to imply that such components are always the same components in all interpretations. For example moving a removeable component from a first location to a second location does not exclude a third location, and does not confine the first location and the second location to always being the same if they are not otherwise defined.

### INDUSTRIAL APPLICABILITY

In addition to the goals stated above, the devices and methods herein can be used for the physical rehabilitation of patients.

### REFERENCE NUMERALS

5 Exoskeletal Device
10 Patient Seating Area
15 Arm Rest
20, 25, 30, 35, 40 Adjustment Mechanisms
50 Arm and Shoulder Attachment
60 Wrist Attachment
95 Motion Control Module
100 Housing
105 internal system
110 finger grips
120 docking slot
130 locking slot
150 shaft
200 Mounting Pad
210 mounting pad hole
220 docking ledge
230 spring-loaded locking latch
240 finger joystick

1. An interchangeable mounting system on an exoskeletal device for controlling motion of joints of a patient, the system comprising:
an exoskeletal device with shaft connections and mounting pads corresponding to axes of rotation of the joints of the patient; and
a motion control module with a housing surrounding a shaft-based internal system that provides at least one of resistance or assistance to a motion of the exoskeletal device through a drive shaft and is connectable to the shaft connections and each of the mounting pads of the exoskeletal device,
wherein the motion control module has a locked position on each of the mounting pads when the drive shaft is in communication with the corresponding shaft connections and the housing is fixed relative to each of the mounting pads.

2. The interchangeable mounting system of claim 1, wherein each of the mounting pads has a locking latch that engages with a locking slot on the housing of the motion control module.

3. The interchangeable mounting system of claim 1, wherein each of the mounting pads has a docking ledge that engages with a docking slot on the housing when the motion control module is in the locked position.

4. The interchangeable mounting system of claim 2, wherein the locking latch is spring loaded and has a finger joystick extending away from each of the mounting pads.

5. The interchangeable mounting system of claim 4 wherein the locking latch is biased by the spring into a locked position and must be actuated by the finger joystick to disengage the locking latch.

6. The interchangeable mounting system of claim 1, wherein the resistance is provided through mechanical dampers inside the housing of the motion control module.

7. The interchangeable mounting system of claim 1, wherein the resistance is provided in proportion to a speed of the motion.

8. The interchangeable mounting system of claim 1, wherein the assistance is provided through an electrical actuator inside the housing.

9. The interchangeable mounting system of claim 1, wherein the assistance is provided for a pre-defined portion of the motion.

10. The interchangeable mounting system of claim 1, wherein the assistance is provided for an entirety of the motion.

11. The interchangeable mounting system of claim 1, wherein the exoskeletal device includes an arm and shoulder attachment having two of the mounting pads.

12. The interchangeable mounting system of claim 1, the motion control module is configured to be moved from a first of the mounting pads corresponding to a first axis of rotation to at least one mounting pad corresponding to a second joint.

13. (canceled)

14. A mounting pad motion control module system, the system comprising:
a mounting pad comprising a docking ledge, a amounting pad hole, and a spring-loaded locking latch;
a motion control module comprising a locking slot, a docking slot, and a shaft,
wherein the motion control module provides at least one of resistance or assistance to a motion of the shaft,
the motion control module is configured to be removably attached to the mounting pad with its shaft penetrable through the mounting pad hole,
the docking slot engages with the docking ledge when the motion control module is placed onto the mounting pad, and
the locking slot engages with a spring-loaded locking latch to hold the motion control module in a fixed position relative to the mounting pad.

15. The mounting pad motion control module system of claim 14, wherein the spring-loaded locking latch is releasable through a depression of an actuator that enables a user to rotate the motion control module relative to the mounting pad.

16. A method for remounting a motion control module on an exoskeletal system, the method comprising:
unlocking a motion control module from a locked position to an unlocked position on a first mounting pad;
removing the motion control module from the first mounting pad causing a drive shaft of the motion control module to be extracted from the exoskeletal system through a first mounting pad hole on the first mounting pad;
moving the motion control module to a second mounting pad and causing a driveshaft of the motion control module to be inserted into the exoskeletal system through a second mounting pad hole on the second mounting pad; and
locking the motion control module from an unlocked position to a locked position on the second mounting pad.

17. The method of claim 16, further comprising a step of disconnecting electrical connections between the first mounting pad and the motion control module and a step of connecting electrical connections between the motion control module and second mounting pad.

18. The method of claim 16, wherein the step of unlocking involves releasing a locking latch from a locking slot and rotating the motion control module.

19. The method of claim 16, wherein the step of locking involves rotating the motion control module until a locking slot engages with a locking latch.

20. (canceled)

21. (canceled)
